(19) United States
(12) Patent Application Publication
(10) Pub. No.: US 2011/0252443 A1
(43) Pub. Date: Oct. 13, 2011

(54) Method and Apparatus for Interfacing Broadcast Television and Video Display with Computer Network

(76) Inventor: Mark Tiddens, Solana Beach, CA (US)

(21) Appl. No.: 13/084,457

(22) Filed: Apr. 11, 2011

Related U.S. Application Data
(60) Provisional application No. 61/322,883, filed on Apr. 11, 2010.

(51) Int. Cl. H04N 5/445

(52) U.S. Cl. 725/38

(57) ABSTRACT

A set-top component for interfacing between a video display screen, and any one of a plurality of sources of displayed video for presentation on the video display. The device employs a microprocessor and software to provide an interface for networked electronic components operating over different communications protocols and cabling ports to allow any electronic component to provide the displayed video for the video display. Also provided is an interface between a smart phone and the video display allowing the smartphone to operate as a remote control for the set-top component and to transmit the displayed video to the smartphone screen allowing remote viewing when a user leaves the room where the video display is located.

### FIELD OF THE INVENTION

This application claims priority to U.S. Provisional Application 61/322883 filed on Apr. 22, 2010, and incorporated herein in its entirety by this reference.

The present invention relates to the presentation of video and images on a video display such as a television or flat panel display. More particularly, it relates to an apparatus and method enabling bidirectional data flow for wirelessly interfacing the video display with computers on a local network, the internet, and broadcast television, allowing the user to employ a conventional television or high definition display for viewing a plurality of video sources concurrently. Control of the system is provided by a conventional remote control or a cellphone or smartphone.

### BACKGROUND OF THE INVENTION

With the advent of high definition television, homes and businesses in the United States have invested in the purchase of ever larger video displays with exceptionally high definition imaging capabilities. In recent years such screens have propagated to occupy a prominent space in most homes and in many cases multiple spaces in many homes have such a high definition screen.

However, to date, most such high definition televisions as well as conventional televisions and displays, are adapted to display only programs broadcast by national networks and cable networks. Such displays have recently afforded the user multiple audio and video inputs to allow the user to connect the display to multiple sources of video and audio. But a device to seamlessly connect the display to the internet and local network computers, and concurrently allow the user to remotely control the resulting plurality of input sources from a single remote control is still lacking. As of yet, no device or method has been provided to afford the user or owner of such a large panel display screen, to initiate an automatic screen-saving function which uses electronic images from a computer on the network as a slide show and/or screen saver. Further the provision of such a device which enables the user to adapt a smart phone or PDA to control it, as well as receive and display the same audio and video being shown by the display has yet to be offered.

As a consequence, owners or users of video displays and high definition flat panel displays, are left to their own devices on how to input multiple sources of audio and video and control them in an organized fashion. Users who are connection-challenged so to speak, and unable to ascertain how to connect for instance to a home or business computer network, and/or one or more computers on the network, and/or the internet, have been left in a lurch. Consequently such low-tech users tend to under-employ their very expensive large video displays positioned in their homes and businesses. Instead, such users view broadcast television on their large display and view their internet sessions on a small remote screen, and have no means to continue viewing either device when they are out of the room for a few minutes for instance to cook.

In the past and more recently, various solutions have been made offered. “Web TV” was originally invented by Microsoft as an option to enable users to view the Internet on their TV. However, Web TV essentially highjacked the screen, ignored other video inputs, and displayed only video concerning the internet. Neither has there been any ability offered, to allow the user to use a video display for audio and video files which are resident on one or more computers of the local area network.

Still further, with the invention of electronic memory devices which require no power source to maintain electronic files, such as “stick drives” and camera memory cards, another potential source of display audio and video is available. However most available flat panel TV's and displays lack the ability of a simple interface with the memory cards. Instead they leave it to the frequently hapless owner or user to ascertain how to communicate with the memory cards to display stored photos or video on the TV flat screen.

Consequently there is an unmet need for a device and method which allow for the individual or concurrent viewing of user-chosen audio and video on their TV display. Such a device and method should operate substantially independently of other devices, to ascertain the type and status of other forms of audio and video available locally which is capable of being communicated to the user's large video display, and automatically provide means to connect them to the display. Such a device and method should enable the user's display to operate as a TV or computer display or both, concurrently, when a user is present. Such a device should enable the display to operate as a slide show using files from any computer communicating on a local network when users are not present, thereby enabling the display to add electronic art to the room it occupies. Additionally, such a device should concurrently provide a means to interface electronic files from one or a plurality of electronic memory chip devices such as USB stick memory and camera memory cards, with the video display screen.

Further, such a device should provide a means to allow the user to adapt Smartphones and PDA's with display screens to both control the system, and to concurrently receive and display the audio and video shown on the display screen on the screen of the PDA or smartphone to allow the user to leave the room and still enjoy the programming being displayed.

With respect to the above, before explaining at least one preferred embodiment of the invention in detail or in general, it is to be understood that the invention is not limited in its application to the details of employment and to the arrangement of the components or the steps set forth in the following description or illustrated in the drawings. The various apparatus and methods of the herein disclosed invention for interfacing local area network sources of audio and video with broadcast television on a single display, are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for implementing electronic components and software which allow for the connection of devices engaged to a local area network automatically to a display. It is important, therefore, that the embodiments, objects and claims herein, be regarded as including such equivalent construction and methodology insofar as they do not depart from the spirit and scope of the present invention.

### SUMMARY OF THE INVENTION

In accordance with the present invention, there is provided an apparatus and method to electronically engage with and a video display such as a high definition flat screen display panel, and interface the display in a bidirectional communication with one or a plurality of computers, or other devices capable of producing video and connected on a local area network. The device also has software and hardware configured to communicate with the internet through the local area network, and communicate the video and audio to one or both of the large screen display panel, or smart phones or remote controls.

### OBJECTS OF THE INVENTION

It is an object of the invention to enable an owner or user of a video display such as a television or flat panel display, with one or a plurality of computers on a local network.

It is another object of the invention to allow a user or owner of such a display, to employ the large screen display, for surfing the internet using a wireless connection to a local network.

It is another object of the invention to provide a means to communicate between the large screen display and the internet and with video files upon any networked computers, and do so automatically.

It is an additional object of the invention to provide a user configurable screen saver or slide show which employs electronic images stored on one or a plurality of computers in communication with a local area network.

A still further object of the invention is to provide software and bidirectional communications which allow for the employment of smartphones and PDA's to operate as a remote control for what is displayed upon the display screen.

It is another object of the invention to provide for the bidirectional communication between such PDA's and smartphones whereby the video displayed on the video display of the system is concurrently displayed on the small screen of a PDA or Smartphone used as the remote control.

An additional object of the invention is employing the device to display files from a smartphone or PDA upon the large display screen of the home or office.

A still further object of the invention is to provide virtual inputs negating the need for a user to hook cables to a video display whereby a plurality of software windows are provided, each with a different source of audio and video from broadcast programming, the internet, or electronic media files hosted on a computer in communication with a local area network.

Another object of the invention is to provide a means for video conferencing to the user employing either the large video display or a communicating PDA or smartphone.

The foregoing has outlined some of the more pertinent objects of the invention provided by the apparatus and system herein. These objects should be construed to be merely illustrative of some of the more prominent features and applications of the intended invention. Many other beneficial results can be attained by applying the disclosed system and apparatus in a different manner or by modifying the invention within the scope of the disclosure.

Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

FIG. 1 is a graphic depiction of the bidirectional interface provided by the device and method herein with the internet, computers on a network, and smartphones and PDA's.

FIG. 2 is a block diagram view of the bidirectional communication flow provided by the device and method herein.

FIG. 3 depicts an optional but preferred provision of the system herein which allows for windows to display the plurality of display sources to the display.

FIG. 4 depicts an optional but preferred provision of the system whereby cell phones and a PDA are enabled for bidirectional communication for controlling the system and displaying the video remotely to the cell phone or PDA.

### DETAILED DESCRIPTION OF THE PREFERRED EMBODIMENTS

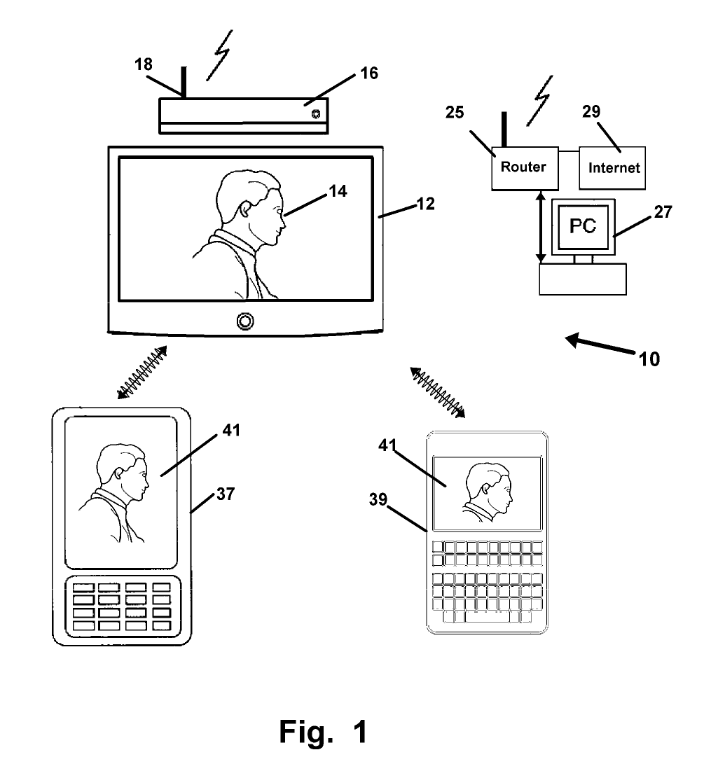

Referring now to the drawings 1-4, wherein similar parts of the disclosed system 10 and apparatus of the disclosed invention are identified by like reference numerals, there is seen in FIG. 1 a graphic depiction of the system 10 provided by the components and software configured to run upon them and employ the method herein disclosed.

As depicted there is shown the display screen 12 which may be a flat panel display such as an LCD Display or a Plasma Display or a projection display or cathode ray tube. As flat panel display screens 12 have become more common with the advent of high definition television, such displays with their multiple inputs for audio/video play are more probable. Depicted on the display screen 12 is displayed video 14 which the system 10, employing software and interfaces running on microprocessor operatively engaged thereto and located in a set top device 16, will ascertain and communicate in the proper audio and video standard to the display screen 12. This communication is provided over conventional cabling or wireless through one or a plurality of the conventional inputs and outputs provided and in operative engagement with the microprocessor on the set top device 16. Such electronic input connectors, and electronic output connectors, communicating with the exterior of the set-top device 16 and in operative engagement thereto, include one or a combination of electronic communication ports from a group of input ports consisting of HDMI, VGA, WiFi, Component Video, computer LAN (“IP” Internet Protocol Suite), and Component Audio connectors for cabling employing connectors for HDMI, component video, VGA, CAT5, and other conventional standard input and output connector ports adapted to engage the terminating ends of the correct cabling.

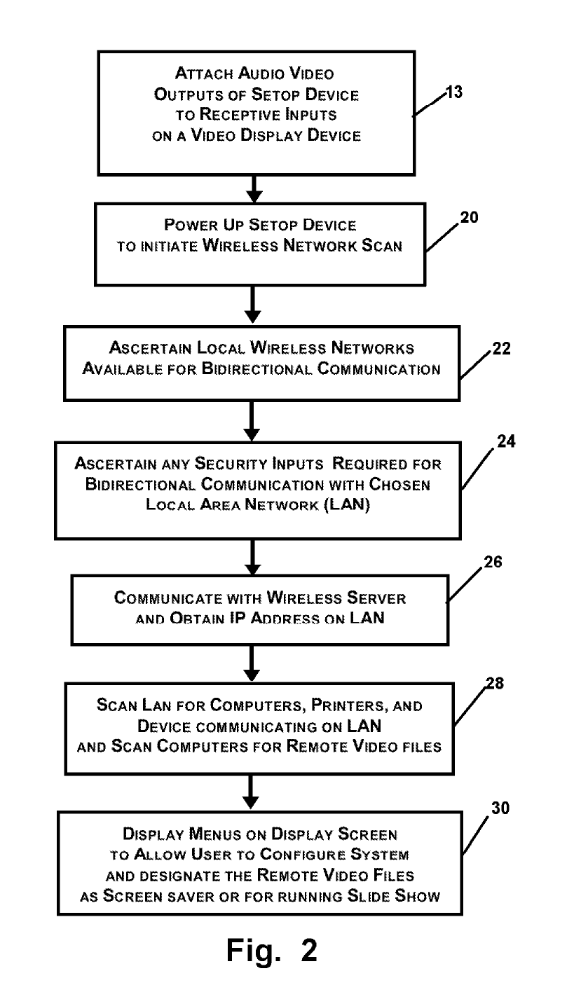

In a first step 13, (FIG. 2) a bidirectional communication between a set-top device 16 and the display screen 12 may be enabled through a cabled connection, preferably between an HDMI port of both the display screen 12 and that operatively engaged with the microprocessor on the set-top device 16. Employing the HDMI communication will provide means to communicate both video to the display screen 12 for the displayed video 14 and audio signals, if any, to speakers of the system.

The set-top device 12 has onboard electronic memory operatively engaged to its microprocessor which operates software configured for the system 10. The electronic memory enables the system 10 to operate as a microcomputer, and employ software configured to the interface tasks herein for operations. Such components are well known for instance in the form of a PC board with RAM memory and operatively engaged to one or both of a hard drive and electronic memory, and having the input and output connectors engaged to a buss, and appropriate software drivers for interfacing with the system software and the microprocessor.

The set-top device 12 is equipped with a wireless communication component 18 operatively engaged with the communication buss to the microprocessor or PC board. The software running on the system employs software drivers configured for wireless communication with other computers directly or through a network router, or other wireless systems. The wireless communication component 18 operates on a frequency and employs a conventional communication standard allowing for broadband high speed communication. Currently preferred is the employment of BlueTooth or more preferably the WiFi standard, since it is well established as a standard mode for bidirectional communication between components with high speed data transmission. However standards change and those skilled in the art will realize that any wireless communication, capable of interfacing and bidirectional communication at a high rate may be employed and such is anticipated within the scope of this patent.

Once electronically engaged to the display screen 12 the set-top device 16 when powered up 20 and employing the software configured to do so, will initiate a scanning mode. In this scanning mode, the set-top device 16 will scan the airwaves 22, and also scan the CAT5 system if connected, and ascertain any one or combination of wired or wireless local area networks (LAN) 22, for which it is adapted to communicated such as a WiFi network handled by a router. The LANs available will then be probed to ascertain if security is enabled and if a standard and password needs to be enabled for the wireless bidirectional communication with a chosen LAN 24. Such will be sought from the user in this scanning and ascertaining step.

Subsequent to inputting of any security inputs for wireless bidirectional communication with a chosen LAN 24, software adapted to the task and running on the set-top device 16 will communicate with the LAN server or router, and obtain an IP address on the LAN 26. When wireless, such servers or routers conventionally employ a wireless router 25 (FIG. 1) which serves to assign electronic addresses in the form of IP addresses, to interface one or a plurality of networked computers 27 and device engaged upon the LAN and also to the internet 29 through a wide area network (WAN) connection at the router.

The system 10, upon obtaining access, and an IP address on the LAN, and employing software running on its microprocessor and configured to the task, will employ the set-top device 16 to scan the LAN for computers, printers, and any other devices communicating on the LAN 28 and identify them, and inventory the discerned devices in lookup memory. The scan of the LAN 28, will also employ software running on the set-top device 16 configured to ascertain the location of any video files or libraries present on all connected devices to the LAN 28. The locations will be inventoried in a lookup file in memory. Once ascertained, such video files will be employed as the displayed video 14, to provide a screen-saver means or to provide an ongoing slide show on the display device 12 when not in use by the user for TV or other viewing.

This scanning of the LAN 28, and inventorying of video files step, is a particularly preferred component and step of operation of the system 10 since it allows the user to employ the system 10 to provide ongoing slide shows on the display device 12. Further, if the display device 12 lacks a screen-saver function, which can cause damage to the screen, the system 10 provides that function in the form of slide shows or random projections of found and communicated video files found on the computers and device ascertained as on the LAN 28 during each scan for computers 28 and housed video files thereon.

Optionally, but preferred, the user may be given a menu to pick video files discovered in the LAN 28 scan, for preferred projection on the display device 12. However the system 10 may also default to finding caches of electronic images stored on individual computing device and network storage devices, and the like, and other devices such as smartphones, which are communicating with the LAN 28. The system 10 having inventoried the electronic locations of the video files on the LAN 28, will then employ them to generate slide shows on the display device 12. The choosing of files for projection by the user may be offered as part of a display of menus 30 allowing the user to also set up the operation of the system 10 using the onboard software configured to that task, and during subsequent operation in the chosen mode.

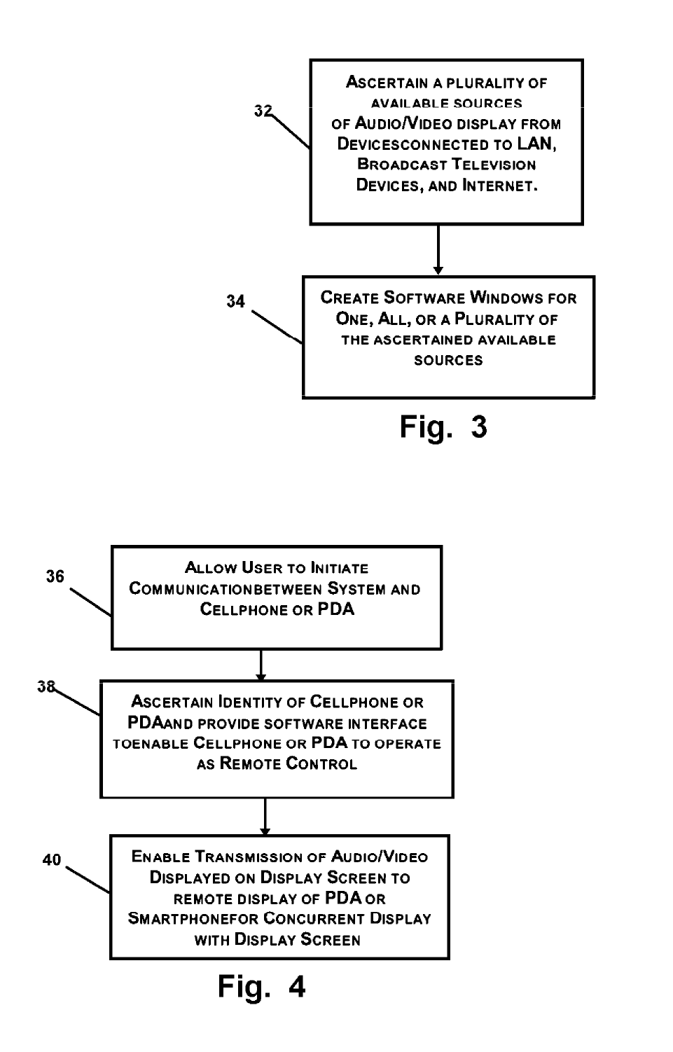

Another optional but preferred mode of the system configuration is shown in the steps of FIG. 3 wherein the software running on the set-top device 16 is scan the connected electronic device on the LAN 32 for all devices connected and adapted for communicating with the set-top box 16 system 10, including computers 27, the internet 29, smartphones, and any memory device docks for stick memory or USB memory devices. This seek and find video files and communicating devices in the LAN 32 scanning, may be repeated daily or periodically by default.

From the scan of the LAN 32 the software running on the set-top device 16 will provide one or a plurality of windows or virtual displays to each electronic device or memory component ascertained as in communication on the LAN 32, and if the user is asked, chosen. This will allow the user to employ the display screen 12 to display one or a plurality of display windows with the displayed video 14 being different in each window for each source.

As shown in FIG. 4, a particularly preferred mode of the system 10 will allow for the use of a smart phone such as the MOTOROLA DROID or the APPLE IPHONE, or a PDA or other phone capable of wireless local communication, for instance over bluetooth, or using RF, to operate as the remote control 36 for the system 10. In this mode, the system 10 employing software configured to the task and running on the microprocessor of the set-top device 16, will initiate a bluetooth, or WiFi or other mode of wireless communication in an electronic handshake with the user smartphone 37 or PDA 39. The software running on the system 10 will thereafter identify the type of smartphone 37 or PDA 39 answering a handshake, and provide an interface 38 for the ascertained device to operate as a remote control.

The interface 38 may be communicated to the ascertained device as an “app” in the form of a small software program, or may discern the device ascertained in the handshake has its own software capable of the task. Using the provided “app” or the ascertained device's software, the system will initiate communication which will allow for bidirectional communication between the set-top device 16 and the identified smartphone or PDA.

If the smartphone has a display screen 41, the provided interface, especially if transmitted as an “app” can also provide for a virtual control surface to be projected on the screen 41 of the smartphone 37 or PDA 39. This would be enabled by using a widget or the “app” communicated from the set-top device 16 once the software adapted to the task of identifying the respective portable device ascertains an identity. This will allow the user to customize the remote control provided by the smartphone 37 or PDA 39 to control the system 10 instead of using keys not specifically designed for such.

Also particularly preferred once the bidirectional communication is achieved, will be the transmission wirelessly of the displayed video 14, directly to the smartphone 37 or PDA 39. This will allow for a concurrent display of the displayed video 14, on both the display screen 12 and the screen 41 of the smartphone 37 or PDA 39 or similar device. Users thereby will have a transportable secondary display source of the displayed video 14 to view, if they should leave the room where the display screen 12 is located thereby allowing them to maintain a viewing of a program or show.

In addition to allowing the smartphone 37 or PDA 39 or similar device to operate as the remote control for the system 10 and to display the displayed video 14 on their respective small screens, the bidirectional communication employs software adapted to allow for display upon the display screen 12, of the contents of the smartphone 37 or PDA 39. Photos, recordings, or even the database held on such portable devices will be able to be displayed upon and reviewed on the display screen 12.

Finally, as noted above, the system 10 scans the LAN to identify any devices in communication with the LAN that may be employed in combination with the system 10 and other devices identified. If a LAN-CONNECTED printer is identified, the system 10 using software configured to the task, will allow the user to print displayed media from the display screen 12, or from any communicating smartphone 37 or PDA 39 or similar portable device operating with the system 10 as a remote control or just in communication with the LAN and so identified.

While all of the fundamental characteristics and features of the disclosed method and apparatus for interfacing computers and an LAN engaged devices with a video display have been shown and described, a latitude of modification, various changes and substitutions are intended in the foregoing disclosure. It will be apparent that in some instance, some features of the invention may be employed without a corresponding use of other features, or steps may be rearranged for operations, without departing from the scope of the invention as set forth. It should be understood that any such substitutions, modifications, and variations, may be made by those skilled in the art, without departing from the spirit or scope of the invention. Consequently, all such modifications and variations are included within the scope of the invention as defined herein.

What is claimed is:

1. An interface apparatus for interfacing between a video display screen, and a plurality of sources of displayed video thereon, comprising:
a microprocessor having electronic memory and power supply;
one or a plurality of electronic input communication ports from a group of input ports consisting of HDMI, VGA, WiFi, Component Video, computer LAN, and Component Audio;
one or a plurality of electronic output communication ports from a group of input ports consisting of HDMI, VGA, WiFi, Component Video, computer LAN, and Component Audio;
software configured to link input signals of video and/or audio communicated in an input standard matching said input communication ports, to said output ports in an electronic standard of said output ports;
said video display screen operatively connected to one of said output ports;
said software having a seek routine to ascertain potential wired or wireless connections available to said interface apparatus;
said software having a security input routine allowing user input of any security inputs required to connect to a chosen one of said connections;
said software having an inventorying routine, said inventorying routine ascertaining connected electronic components capable of electronic communication with said interface apparatus over said connection;
said inventorying routine also ascertaining electronic video files and audio files available to said interface apparatus on each respective electronic component;
internet software running on said microprocessor, said interface software configured to ascertain an internet connection available and connecting thereto;
said interface apparatus, employing software configured to provide a displayed interface on said display screen, providing said user a graphic interface to choose any one said connected electronic component communicating through any input port, to provide said displayed video on said displayed screen; and
said graphic interface providing said user means to choose to communicate said internet as said displayed video.

2. The apparatus of claim 1 additionally comprising:
a secondary interface operatively engaged between said interface apparatus;
said interface apparatus having control software adapted to identify and connect a communicating portable electronic device from a group including a smart phone, a cellular phone and a PDA in a bidirectional wireless electronic communication; and
said control software enabling said portable electronic device to function as a remote control to control said interface apparatus.

3. The apparatus of claim 2 additionally comprising:
said portable electronic device having a display screen; and
said bidirectional wireless communication transmitting said displayed video to said display screen of said portable electronic device.

4. The apparatus of claim 1 additionally comprising:
said apparatus having screen saver software running upon said microprocessor; and
said screen saving software employing said video files ascertained during said inventorying routine as available to said interface apparatus from a said electronic component, as the displayed video.

5. The apparatus of claim 2 additionally comprising:
said apparatus having screen saver software running upon said microprocessor; and
said screen saving software employing said video files ascertained during said inventorying routine as available to said interface apparatus from a said electronic component, as the displayed video.

6. The apparatus of claim 3 additionally comprising:
said apparatus having screen saver software running upon said microprocessor; and
said screen saving software employing said video files ascertained during said inventorying routine as available to said interface apparatus from a said electronic component, as the displayed video on both said display screen and said display screen of said portable electronic device.
